(19) United States
(12) Patent Application Publication
(10) Pub. No.: US 2012/0294219 A1
(43) Pub. Date: Nov. 22, 2012

(54) METHOD AND APPARATUS FOR MOBILE MARKET SERVICE TRANSACTIONS

(75) Inventors: Winfried Lendler, Laupheim (DE); Detlef Peter, Bibertal (DE); Anton Schultheiß, Ulm (DE); Melanie Toth, Ulm (DE); Gabriel Ferris-Gari, Ulm (DE); Thomas Aicher, Munchen (DE)

(73) Assignee: Nokia Corporation, Espoo (FI)

(21) Appl. No.: 13/110,681

(22) Filed: May 18, 2011

(51) Int. Cl. H04W 4/06

(52) U.S. Cl. 370/312

(57) ABSTRACT

An approach is provided for receiving a request to broadcast at least one message associated with one or more market transactions. The approach further involves causing, at least in part, a conversion of the at least one message to a format for embedding into at least one broadcast signal. The approach also causes, at least in part, a transmission of the at least one converted message via the at least one broadcast signal.

### BACKGROUND

Service providers and device manufacturers (e.g., wireless, cellular, etc.) are continually challenged to deliver value and convenience to consumers by, for example, providing compelling network services. One area of development relates to delivering such services over existing infrastructure. For example, radio stations often broadcast messages or information (e.g., channel information, song information, and related metadata broadcast in a radio data system (RDS) or other similar format) over the traditional broadcast signals. At the same time, market services that, for instance, enable consumers to buy and sell merchandise have become popular. Accordingly, service providers and device manufacturers face significant technical challenges to delivering such mobile market service transactions and/or other service information over infrastructures such as the radio broadcast systems.

### SOME EXAMPLE EMBODIMENTS

Therefore, there is a need for an approach for efficiently transmitting service information over a radio broadcast system.

According to one embodiment, a method comprises receiving a request to broadcast at least one message associated with one or more market transactions. The method also comprises causing, at least in part, a conversion of the at least one message to a format for embedding into at least one broadcast signal. The method further comprises causing, at least in part, a transmission of the at least one converted message via the at least one broadcast signal.

According to another embodiment, an apparatus comprises at least one processor, and at least one memory including computer program code, the at least one memory and the computer program code configured to, with the at least one processor, cause, at least in part, the apparatus to receive a request to broadcast at least one message associated with one or more market transactions. The apparatus is also caused to cause, at least in part, a conversion of the at least one message to a format for embedding into at least one broadcast signal. The apparatus is further caused to cause, at least in part, a transmission of the at least one converted message via the at least one broadcast signal.

According to another embodiment, a computer-readable storage medium carries one or more sequences of one or more instructions which, when executed by one or more processors, cause, at least in part, an apparatus to receive a request to broadcast at least one message associated with one or more market transactions. The apparatus is also caused to cause, at least in part, a conversion of the at least one message to a format for embedding into at least one broadcast signal. The apparatus is further caused to cause, at least in part, a transmission of the at least one converted message via the at least one broadcast signal.

According to another embodiment, an apparatus comprises means for receiving a request to broadcast at least one message associated with one or more market transactions. The apparatus also comprises means for causing, at least in part, a conversion of the at least one message to a format for embedding into at least one broadcast signal. The apparatus further comprises means for causing, at least in part, a transmission of the at least one converted message via the at least one broadcast signal.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of broadcasting mobile market service transactions, according to one embodiment;

FIG. 2 is a diagram of the components of an broadcast processing platform, according to one embodiment;

FIG. 3 is a flowchart of a process for broadcasting mobile market service transactions, according to one embodiment;

FIG. 4 is a flowchart of a process for receiving a broadcasted message at a device, according to one embodiment;

FIG. 5 is a diagram illustrating the flow of information through the system discussed above, according to various embodiments;

FIGS. 6A and 6B are example user interfaces for inputting a message and for receiving a message, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for broadcasting mobile market service transactions are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are describe with respect to broadcasting messages over a radio data system (RDS) format or a radio broadcast data system (RBDS), it is contemplated that the approach described herein is applicable to any format for embedding messages for transmission of a radio broadcast system. By way of example, such radio broadcast system include, but are not limited to, FM radio, AM radio, satellite radio, cable radio, high definition (HD) radio, Internet radio, and the like.

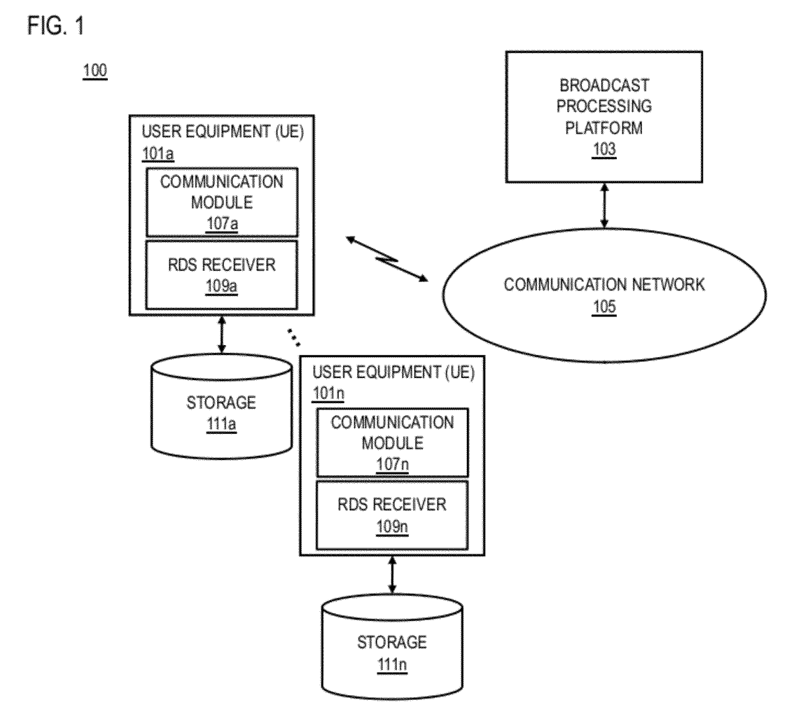

FIG. 1 is a diagram of a system capable of broadcasting mobile market service transactions, according to one embodiment. Today's private and professional offer, sell and buy market is usually done by way of newspaper advertising (e.g., classified-ad section) and internet selling platforms such as Ebay, Amazon, Craigslist, etc. However, many people do not have access to newspapers and internet, or cannot afford it. But, people often want to offer, sell and buy merchandise. Craftsman, individual sellers, or small shops may not be able afford newspaper, magazine, radio, television or internet advertising. Or, there may not even be a local newspaper available to offer items for sale. Even if the above-mentioned modes of advertising are available to a seller, these methods are typically expensive and slow, and are presented to consumers at a time later than may be desired by the seller.

To address this problem, a system 100 of FIG. 1 introduces the capability to broadcast mobile market service transaction messages over a radio broadcast system. In one embodiment, the system 100 receives a message such as an advertisement from a seller by way of a textual or audio input, converts the message to an RDS format (or other format for embedding messages in a broadcast signal), and then transmits the message in the RDS format or other format to electronic devices that are capable of receiving such formatted data (e.g., RDS data). For example, many conventional FM radio stations are transmitting RDS data in addition to a conventional audio signal. This data typically includes, among other things, station name, artist, song title information, and news feeds. Many FM receivers are able to decode RDS data and show the text on a device display. Also most mobile phones with an integrated FM receiver are able to decode RDS data. Mobile phones are able to send messages via short message service (SMS) to other devices such as mobile phones, PCs through the internet/email, Fax machine, etc.

It would be advantageous to implement a service that is available to a large number of people to offer, sell and buy merchandise. Such a service may be accomplished by sending an advertising message by way of SMS to the FM station or any other service provider such as an AM station, satellite radio service provider, cable radio, HD radio, or any frequency or transmission mode capable of displaying a message on a receiving end. The FM station may convert the received message to an RDS format and add the offer to their RDS data and broadcast it. Any FM RDS receiver device in the distribution area of the FM station can decode the RDS data and show the offer on the display. The user of such a device may then decide if he wants to buy the item that is advertised by the seller.

This mode of advertising is faster than newspaper, does not require Internet access, and is available to a large number of people. The infrastructure of such a service is readily available most everywhere.

Applications for mobile phones, various input devices, and/or FM radio receivers can enhance the above-mentioned advertising service. For example, a mobile device, or other input device, may be provided with an input template for easing sending of an SMS message to the FM radio station or service provider. An application may be available for the RDS receiver device so that the received offering text may be saved in the RDS receiver device's memory. Further, applications for the RDS receiver may enable sorting the text list by different parameters (keywords, date, time, etc.), providing search function for input keywords, dates, times, etc., trigger an alarm if a keyword matches to any portion of the broadcast RDS data when it is broadcast by the service provider, saving offers that include matching keywords, and/or a schedule timer for the saving function to save only the offers broadcast during a specific timeframe, for example.

Saving the received offer text at the device memory may allow a user to check the offers later, and the saving may be done even if the user is not listening to the FM radio (i.e. the radio is off or offline). Also, because there may be thousands of offers for sale that may overwhelm a user, providing for a search function for certain keywords enables the possibility of screening advertisements to that only offers that contain specific predefined keywords are shown. Further, because the number of advertisements may overwhelm a user, it may also be helpful to enable the search function to search based on specific dates, time of the offer and price range. For example, a user may not care to look for an advertisement for an item that is over a week old because the item for sale is likely already sold. Also, a user may also only want to view items that he may actually be able to afford. It may also be advantageous to provide a means for sorting the text list by different parameters (i.e. keywords, date, time, etc.) so that the offers may be quickly and easily viewed by the user. The above-mentioned alarm feature may be beneficial because if the alarm is triggered by a particular offer, the user is immediately informed of the item/keyword occurrence, and can react quickly to the advertisement. A system may also be integrated that allows for the advertised items to be sold by way of an auction system that collects and processes multiple bids from respondent consumers, yields a final winning bid, and notifies the winner of his successful purchase.

The above-mentioned SMS message that is sent by a seller to the service provider may include any information such as item offered for purchase, price, telephone number or other contact information. When the message is displayed on the RDS receiver, the message may appear for any preset period of time. For example, the message may appear for 15 seconds before another message or other RDS data is displayed.

There is also the possibility to use Radio Text Plus (RT+) format. This enables the RDS text to be sent in a more structured way. This means that the RDS receiver is able to detect which part of the text is the phone number, is it an offer or query etc. This may require an update of the RT+ Category and RT+ classes (RDS standard).

The seller may send an SMS with his offer to a service number. This number may be provided by the FM Radio Station or a service provider. The SMS is received and the text may then be copied to the RDS Text field for conversion to the RDS format. This can be done manually by an operator or automatically by an application. The SMS message, one converted, may then be broadcasted by the FM Radio station via RDS. All RDS enabled receivers within the broadcast rand of the service provider (e.g., mobile phone, FM receiver, etc.) will receive the RDS Text. The text can be displayed on the device display, converted to audio if so desired, and/or stored into the device's memory. The user of such a device may then call, send a SMS, or email to the number or contact information that is included in the RDS text, to show his interest in the offer.

As shown in FIG. 1, the system 100 comprises a user equipment (UE) 101a-101n, collectively referred to as —UE 101 having connectivity to broadcast processing platform 103 via a communication network 105, according to one embodiment. In one embodiment, a seller inputs an advertisement for an item for sale into the UE 101 to send via SMS by way of a communication module 107a-107n, collectively referred to as communication module 107 to the broadcast processing platform 103. The broadcast processing platform 103 receives the SMS message from the UE 101 and checks the message for keywords that may be set to determine appropriateness, or distribution to a particular audience. For example, an advertisement for a saxophone may be sent to a jazz station, whereas an advertisement for Christmas lights may be sent to a station that plays Christmas music. The broadcast processing platform 103 converts the SMS message into an RDS format and then transmits the input advertisement to a plurality of UE 101's that are all tuned into the requisite station. The UE's 101 may then receive the advertisement in RDS format. The UE's 101 receive the RDS data by way of an RDS receiver 109a-109n, collectively referred to at RDS receiver 109, that is capable of receiving and processing RDS data from a service provider or radio station. The received advertisement may have information about an item for sale, price, location, contact information such as a telephone or email address, location of sale etc. This would enable the buyer to contact the seller directly, or visit the seller personally. The advertisement may also have a dedicated service number for calling in response to the ad rather than, or in addition to the seller's inputted number. In one embodiment the service number is sent to the UE's 101 and the UE's 101 can store the service number relating to the radio station's market place. The dedicated service number may enable the buyer to deal with an operator that supports the sale, or a system that supports an auction sale environment. A system that handles the sale by way of the dedicated service number may also inform a buyer that the item is still available, already sold, or if it is no longer available. The additional backend system may be run by a radio station or service provider.

In certain embodiments, a user may input preferences into the UE 101 so that RDS data that is transmitted to the UE 101 is filtered to detect certain keywords and an alarm may be triggered to alert the user that a relevant advertisement has been received by the UE 101. The UE 101 may also be tied to, or include, a storage 111a-111n, collectively referred to as storage 111, that stores received RDS data for future viewing by the user. The storage may be based on preferences such as keyword, date, time, and may be sorted and classified based on user preferences.

In certain embodiments, the UE 101 may be tied to a social networking service and the input for conversion to the RDS format may be from a status update on the social networking service. For example, a user may want to advertise an item for sale by way of adding the item for sale on the social networking service, or simply by indicating the item is for sale in their status message.

In certain embodiments, users may bid to have their advertisements converted and broadcast as RDS data. The bidding may not be limited to advertisements for items for sale, but may also be expanded to messages or “shout outs” to friends. For example, a user wants to have a message displayed at a certain time such a “will you marry me” via RDS data. While this may be a terrible way to propose, such a message may be input into the UE 101 and converted to RDS format for broadcasting. The broadcast processing platform 103 may not filter out such a message if the broadcast processing platform 103 determines that the message is genuine based on a particular bid for displaying the message. Otherwise, without a bid, for example, the broadcast processing platform 103 may determine that only advertisements for items for sale are to be converted and broadcast for display. However, bidding may not be necessary if there is enough space available for extraneous, non-advertising messages so long as the broadcast processing platform 103 determines that the offer is valid based on certain filtering criteria.

In certain embodiments, the broadcast processing platform may gang similar advertisements together for broadcasting on related stations, or for broadcasting at the same time.

The broadcast processing platform may also enable broadcasting of the advertisement immediately upon approval and conversion. Alternatively, the broadcast processing platform may isolate similar advertisements from one another and stagger them throughout the day so that they do not appear to blend together to potential buyers. This anti-blending feature, however, may be annulled by the sorting feature discussed above for viewing saved advertisements on the UE 101.

In certain embodiments, the broadcast processing platform 103 may transmit an indication to the user of the UE 101 from which the advertisement or message was input indicating that the message has been converted and broadcast, or an indication of a station and time that the advertisement or message will be broadcast. This would enable the user to view the user's own advertisement to verify its accuracy. This may be particularly advantageous if, for example, the user wants his item advertised on a popular Top-40 station as opposed to a not so popular talk radio station. The user may have an opportunity to alter the path of the advertisement before it is sent, or to send another advertisement. The user may also have the option to specifically direct the advertisement to a specific radio station to promote his item.

In certain embodiments, the broadcast processing platform 103 may have an anti-spamming module that limits the number of advertisements related to a product, a source phone number or IP address, or a contact number or email address. The number may be so limited so that others may have access to the system and the system is not overloaded by a person that takes advantage of the ease of displaying a message via RDS data.

In certain embodiments, a message that is input via SMS, for example for the UE 101 may be sent by short range radio transmission directly to other enables UE 101 within a proximity of the seller. For example, if a seller has a limited supply of items at a location and wants them to go quickly, he may be able to send a mass message to users within the proximity to amass immediate attention. Such short range transmission may be via Bluetooth, or other short range radio transmission, for example.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and the broadcast processing platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

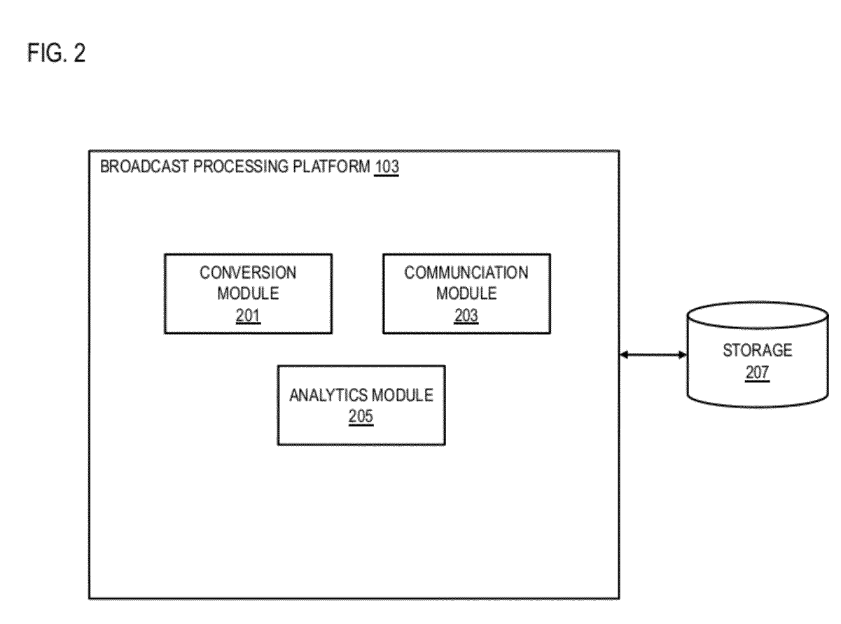

FIG. 2 is a diagram of the components of the broadcast processing platform 103, according to one embodiment. By way of example, the broadcast processing platform 103 includes one or more components for converting a non-RDS formatted message to an RDS format and broadcasting the message in the RDS format. It is contemplated that the functions of these components may be combined in one or more components or performed by other components of equivalent functionality. In this embodiment, the broadcast processing platform includes a conversion module 201, a communication module 203 and an analytics module 205. The broadcast processing platform 103 may also include, or be connected to a storage 207.

In one embodiment, the conversion module 201 converts a message received from a UE 101 by way of the communication module 203 from a non-RDS format to and RDS format. The analytics module 205, either before or after the RDS conversion, may analyze and filter the message that is requested to be broadcast by a user of UE 101 for appropriateness, matching a keyword, time, data and/or station preference. The analytics module 205 may determine if and when the message should be broadcast and output by way of the communication module 203. The analytics module 205 may also determine the amount of time an advertisement or message that is in the RDS format is to be displayed for on the UE 101 when it is output for transmission to the UE's 101. The analytics module 205 may save RDS data in the storage 207 for later broadcasting and/or review. The analytics module 205 may also initiate a message to be sent to the originating UE 101 to alert the user that his advertisement or message has been broadcast. The analytics module 205 may also determine whether an advertisement or message should be broadcast at a time or station based on the user's requested time, station and possibly a bid for a requested time slot and preferred station. The bid may be entered on the UE 101 and charged to the user through the user's wireless provider or an instant payment method, for example.

In certain embodiments, the analytics module 205 may also aggregate similar advertisements together so that they are broadcast on the same channel or at the same time or in the same time frame which can be provided to users as part of a program guide of that radio station to provide users the program guide when to see advertisements from area of interest, or the analytics module may purposely segregate all of the similar advertisements from one another. Such ganging or segregation may be based on preferences of the radio station or service provider, or preferences set by the user. For example, if two different users request that their advertisements for washing machines are to be broadcast near one another, the analytics module 205 matches these requests and make the broadcasts occur back-to-back, for example. Alternatively, one of the users may request that his advertisement for a washing machine occur at a time different from the other advertisement so as to avoid confusion with his competitor, the analytics module 205 accommodates the user's request.

In certain embodiments, the analytics module 205 may determine to limit advertisements or messages that come from the same source number, source IP address, have the same contact information, etc., to avoid spam advertising and to enable the system to be available to more users and disallow a few users from clogging the system.

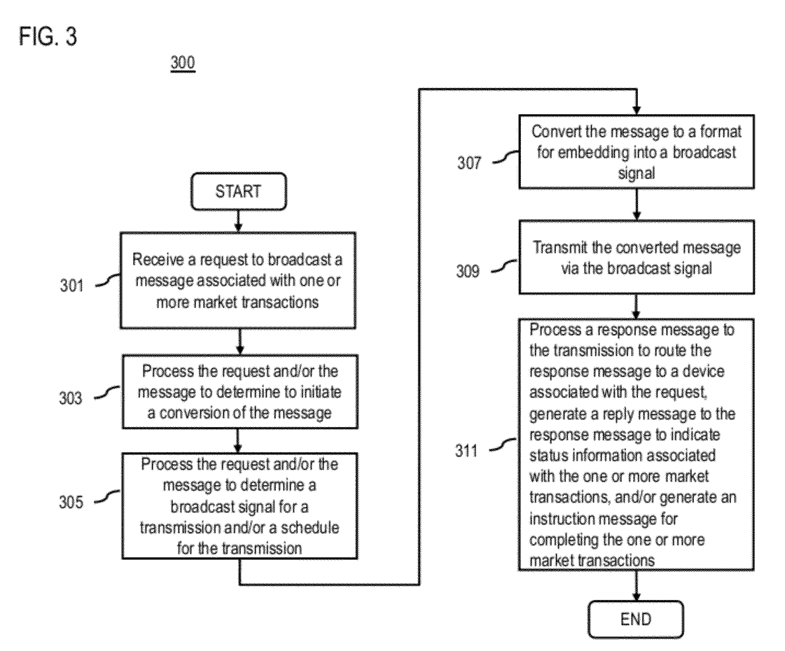

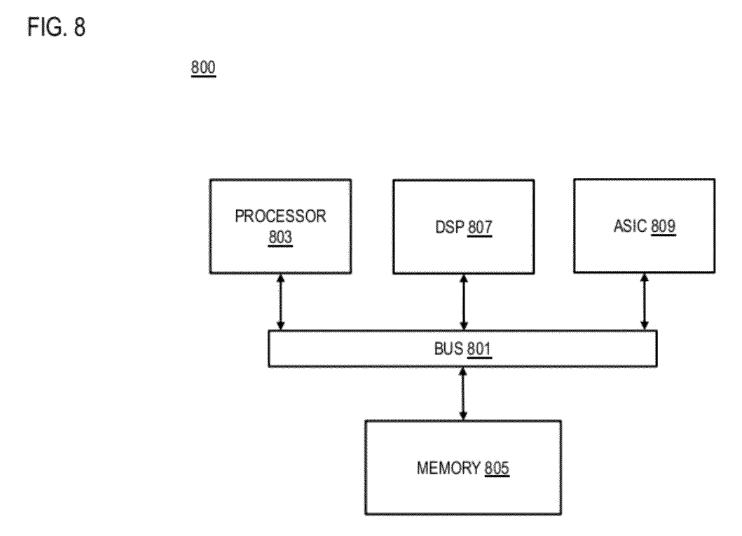

FIG. 3 is a flowchart of a process for broadcasting mobile market service transactions, according to one embodiment. In one embodiment, the broadcast processing platform 103 performs the process 300 and is implemented in, for instance, a chip set including a processor and a memory as shown in FIG. 8. In step 301, the broadcast processing platform 103 receives a request to broadcast a message associated with one or more marketing transactions. The process continues to step 303 in which the request and/or the message is processed to determine to initiate a conversion of the message to a broadcast signal format such as RDS or RBDS. Next, in step 305, the broadcast processing platform 103 processes the request and/or the message to determine a broadcast signal (e.g. a radio station) for the broadcast and/or a schedule of the broadcast. The process continues to step 307 in which the broadcast processing platform 103 converts the message to a format for embedding into a broadcast signal. Next, in step 309, the converted message is broadcast by way of the broadcast signal. Then, in step 311, the broadcast processing platform 103 processes a response message to the broadcast or transmission, and routes the response message to a device associated with the request. The processing platform 103 also generates a reply message to the response message to indicate status information associate with the one or more market transactions, and generates an instruction message for completing the one or more market transactions.

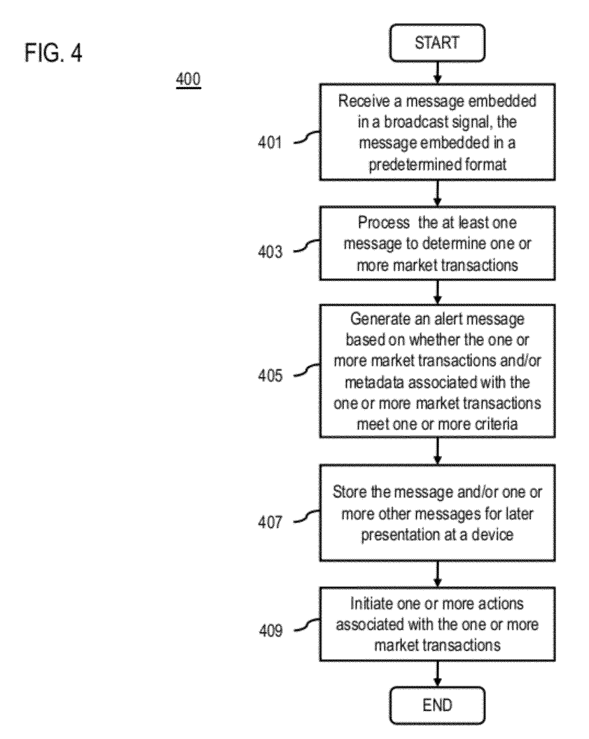

FIG. 4 is a flowchart of a process for receiving a message embedded in a broadcast signal at a device, according to one embodiment. In one embodiment, the UE 101 performs the process 300 and is implemented in, for instance, a chip set including a processor and a memory as shown in FIG. 8. In step 401, the UE 101 receives a message embedded in a broadcast signal, the message being embedded in a predetermined format. The process continues to step 403 in which the UE 101 processes the at least one message to determine one or more market transactions. Next, in step 405, the UE 101 generates an alert message based on whether the one or more market transactions and/or metadata associated with the one or more market transactions meet one or more criteria. Then, in step 407, the UE 101 stores the message and/or one or more other messages for later presentation at the device. The process continues to step 409 in which the UE 101 initiations one or more actions associated with the one or more market transactions.

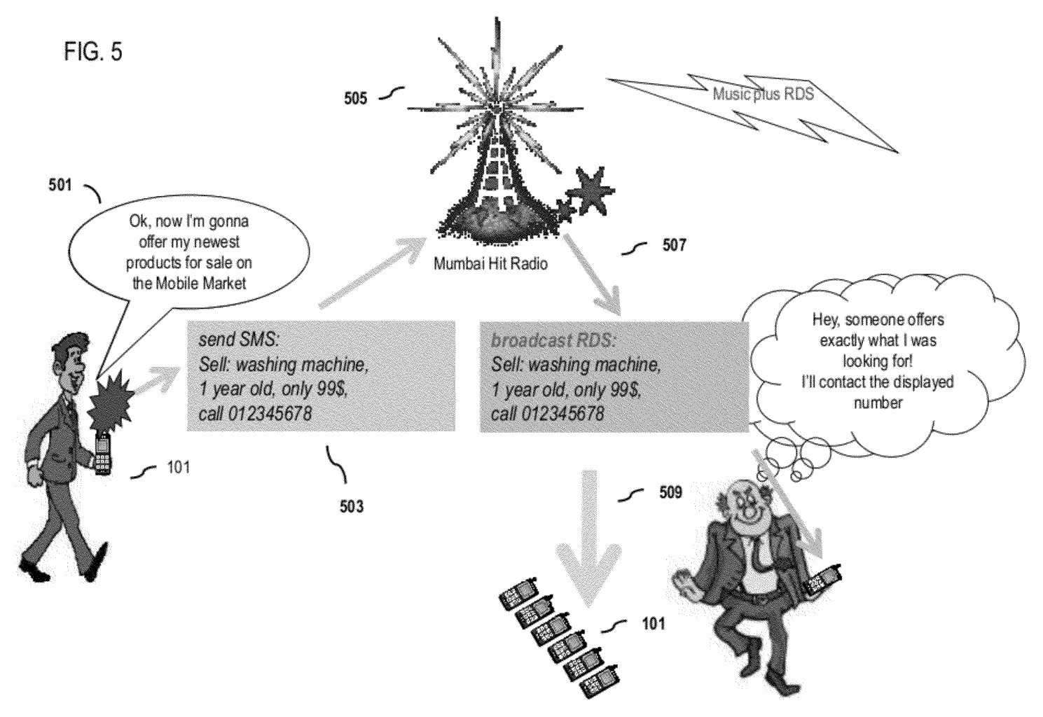

FIG. 5 is a diagram of an example flow of information through the system 100, according to one embodiment. For example, a user 501 of a UE 101 inputs a message 502 to be sent via SMS to an FM radio station 505. The FM radio station 505 converts the SMS message to an RDS format 507 (or other message format) for transmission to other users 509 of UE's 101. The user 509 may review the broadcasted RDS advertisement on his respective UE 101 for a set period of time, for example 15 seconds. The user 509 may then contact the seller or central operating service by way of contact information that is incorporated into the RDS data or the central operating service which number has been provided either through RDS or in advance in RDS or through other ways. Alternatively, or in addition to the contact information, an application that is resident on the UE 101 may have a button or an icon on display of e.g. a touch screen, for example, that enables the user to e.g. instantaneously select and respond to the advertisement that is being displayed at any given moment. Such a button may act as a direct dial, SMS initiator, or email initiator, for example.

In certain embodiments, the UE 101 may also incorporate into an application resident on the UE 101 a pause button to allow the user to freeze an advertisement so that the user does not miss the ad, or rewind if the user wants to review an advertisement that he just missed. The RDS data will continue to be broadcast and saved, depending on the user's set preferences, in the storage of the UE 101. In some embodiments the storage from RDS data is deleted after a predefined time and/or e.g. only advertisements of one day can be loaded and/or a new advertisement of today may be saved on the advertisements received yesterday.

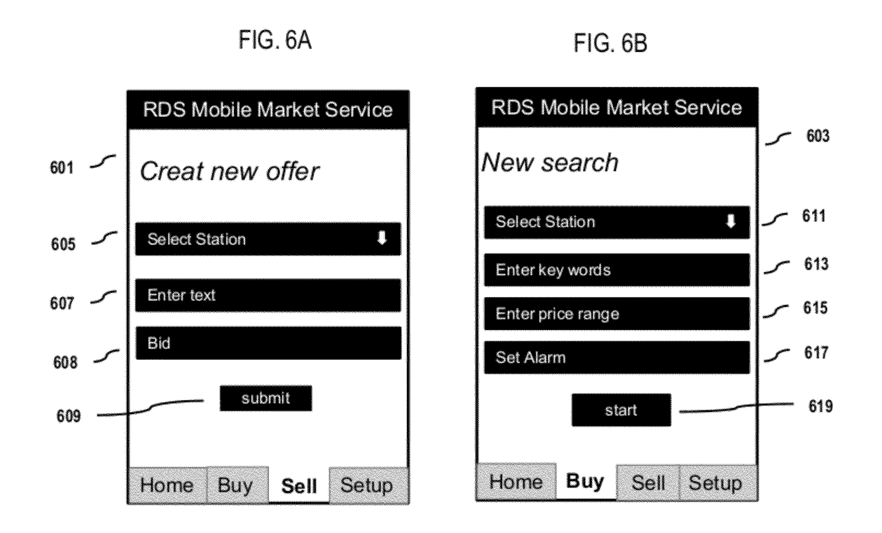

FIGS. 6A and 6B are illustrations of a selling user interface 601 that may be displayed on a UE 101 and a buying interface 603 that may be displayed on a UE 101, according to one embodiment. The selling interface has a station selection drop down box 605 that enables a seller to select which station his advertisement or message is to be broadcast on. The user interface 601 also has an enter text section 607 in which the user may enter the information for the advertisement or message and then submit the message by hitting the submit button 609. Such a user interface may also incorporate other buttons such as a bidding button to enable users to bid for better advertising slots or preferred stations. The user interface 601 may also incorporate a ganging button so that the user may request that his ad be ganged with other similar ads or segregated from similar ads. The bidding button 608 may also be a means for enabling a user to buy an extra amount of time that his advertisement is displayed on the UE 101. For example, for paying more money, the user may get an extra 5 seconds of exposure time. The UI can be a web application. In one embodiment user interface is implemented on a touch screen.

In one embodiment, the buying interface 603 has a series of options that may be customized to enhance the user's buying experience. For example, the user may select a station to listen to and/or receive RDS data from by selecting an available station in drop down box 611. The user may enter keywords in field 613 that may trigger alarms or may limit what advertisements are displayed to the user. The user may also set a price range 615 that limits what advertisements are displayed to the user and also to trigger a potential alarm. The user may use button 617 to set an alarm for a particular combination of preferences. For example, if the user is looking for a blue jacket for $15, and the user enters “blue jacket” into his keyword search, and a price range of $10-$20, when the RDS data is broadcast to the UE 101, and the combination falls within the preset criteria, an alarm may sound that alerts the user to act because his desired item has been put up for sale. In one embodiment the device may have a schedule timer for saving a received advertisement. The broadcast of advertisements of certain category is sent in a predefined time frame, e.g. between 9:00 am and 9:10 am. The device is set to allow for listening to a radio station and/or storing RDS data received during the predefined time. The user may opt for the radio station to be set to mute, if this is the case, the user may later read advertisements received during that time from his device.

In one embodiment, the advertisement, or RDS data may be displayed to the user in any format that the UE 101 can accommodate. The RDS data may be displayed as a banner on a display of the UE 101, or it may also appear in a format similar to a SMS message that the UE 101 receives.

The processes described herein for broadcasting mobile market service transactions may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

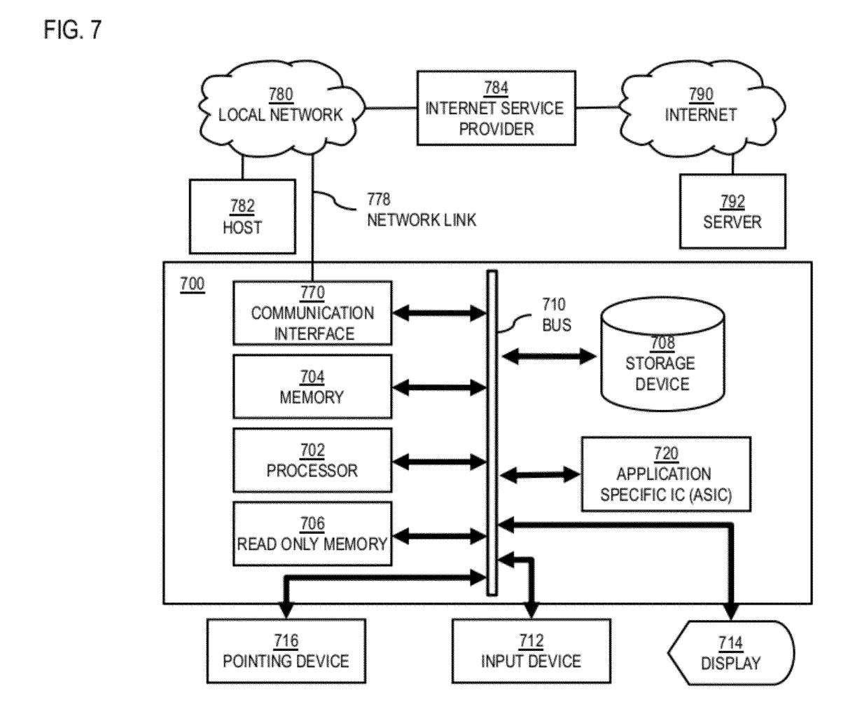

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to broadcast mobile market service transactions as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of broadcasting mobile market service transactions.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to broadcasting mobile market service transactions. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for broadcasting mobile market service transactions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for broadcasting mobile market service transactions, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for broadcasting mobile market service transactions to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to broadcast mobile market service transactions as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of broadcasting mobile market service transactions.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to broadcast mobile market service transactions. The memory 805 also stores the data associated with or generated by the execution of the inventive steps.

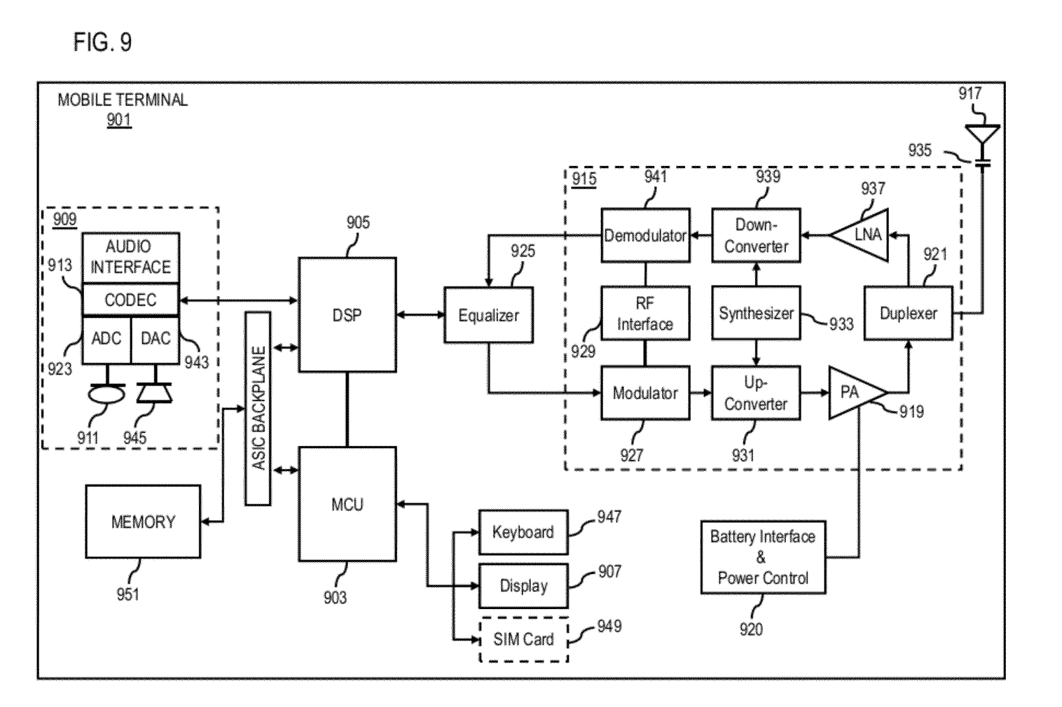

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of broadcasting mobile market service transactions. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of broadcasting mobile market service transactions. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to broadcast mobile market service transactions. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request to broadcast at least one message associated with one or more market transactions;
a conversion of the at least one message to a format for embedding into at least one broadcast signal; and
a transmission of the at least one converted message via the at least one broadcast signal.

2. A method of claim 1, wherein the format includes, at least in part, a Radio Data System (RDS) format, a Radio Broadcast Data System (RBDS) format, or a combination thereof.

3. A method of claim 1, wherein the (1) data and/or (2) information and/or (3) at least one signal are further based, at least in part, on the following:
a processing of the request, the at least one message, or a combination thereof to determine whether to cause, at least in part, an initiation of the conversion, the transmission, or a combination thereof.

4. A method of claim 1, wherein the (1) data and/or (2) information and/or (3) at least one signal are further based, at least in part, on the following:
a processing of the request, the at least one message, or a combination thereof to determine the at least one broadcast signal for the transmission, a schedule for the transmission, or a combination thereof.

5. A method of claim 1, wherein the (1) data and/or (2) information and/or (3) at least one signal are further based, at least in part, on the following:
a processing of one or more response messages to the transmission to cause, at least in part, (a) a routing of the one or more response messages to one or more devices associated with the request, (b) a generation of one or more reply messages to the one or more responses to indicate status information associated with the one or more market transactions, (c) a generation of one or more instruction messages for completing the one or more market transactions, or (d) a combination thereof.

6. A method of claim 1, wherein the at least one message is received via short message service, email, voice input, or any combination thereof.

7. A method comprising facilitating a processing of and/or processing (1) data and/or (2) information and/or (3) at least one signal, the (1) data and/or (2) information and/or (3) at least one signal based, at least in part, on the following:
at least one message embedded in at least one broadcast signal, the at least one message embedded in a predetermined format;
a processing of the at least one message to determine one or more market transactions; and
a generation of an alert message based, at least in part, on whether the one or more market transactions, metadata associated with the one or more market transactions, or a combination thereof meet one or more criteria.

8. A method of claim 7, wherein the predetermined format includes, at least in part, a Radio Data System (RDS) format, a Radio Broadcast Data System (RBDS) format, or a combination thereof, and wherein the criteria include, at least in part, one or more keywords, one or more context criteria, or a combination thereof.

9. A method of claim 7, wherein the (1) data and/or (2) information and/or (3) at least one signal are further based, at least in part, on the following:
a storage of the at least one message, one or more other messages, or a combination thereof for later presentation at a device.

10. A method of claim 7, wherein the (1) data and/or (2) information and/or (3) at least one signal are further based, at least in part, on the following:
an initiation of one or more actions associated with the one or more market transactions,
wherein the one or more actions include, at least in part, a transmission of a response message, an establishment of a communication session with a device associated with the at least one message, a generation of an alert message, a presentation of the at least one message in a structured format, or a combination thereof.

11. An apparatus comprising:
at least one processor; and
at least one memory including computer program code for one or more programs,
the at least one memory and the computer program code configured to, with the at least one processor, cause the apparatus to perform at least the following,
receive a request to broadcast at least one message associated with one or more market transactions;
cause, at least in part, a conversion of the at least one message to a format for embedding into at least one broadcast signal; and
cause, at least in part, a transmission of the at least one converted message via the at least one broadcast signal.

12. An apparatus of claim 11, wherein the format includes, at least in part, a Radio Data System (RDS) format, a Radio Broadcast Data System (RBDS) format, or a combination thereof.

13. An apparatus of claim 11, wherein the apparatus is further caused to:
process and/or facilitate a processing of the request, the at least one message, or a combination thereof to determine whether to cause, at least in part, an initiation of the conversion, the transmission, or a combination thereof.

14. An apparatus of claim 11, wherein the apparatus is further caused to:
process and/or facilitate a processing of the request, the at least one message, or a combination thereof to determine the at least one broadcast signal for the transmission, a schedule for the transmission, or a combination thereof.

15. An apparatus of claim 11, wherein the apparatus is further caused to:
process and/or facilitate a processing of one or more response messages to the transmission to cause, at least in part, (a) a routing of the one or more response messages to one or more devices associated with the request, (b) a generation of one or more reply messages to the one or more responses to indicate status information associated with the one or more market transactions, (c) a generation of one or more instruction messages for completing the one or more market transactions, or (d) a combination thereof.

16. An apparatus of claim 11, wherein the at least one message is received via short message service, email, voice input, or any combination thereof.

17. An apparatus comprising:
at least one processor; and
at least one memory including computer program code for one or more programs,
the at least one memory and the computer program code configured to, with the at least one processor, cause the apparatus to perform at least the following,
receive at least one message embedded in at least one broadcast signal, the at least one message embedded in a predetermined format;
process and/or facilitate a processing of the at least one message to determine one or more market transactions; and
cause, at least in part, a generation of an alert message based, at least in part, on whether the one or more market transactions, metadata associated with the one or more market transactions, or a combination thereof meet one or more criteria.

18. An apparatus of claim 17, wherein the predetermined format includes, at least in part, a Radio Data System (RDS) format, a Radio Broadcast Data System (RBDS) format, or a combination thereof, and wherein the criteria include, at least in part, one or more keywords, one or more context criteria, or a combination thereof.

19. An apparatus of claim 17, wherein the apparatus is further caused to:
cause, at least in part, a storage of the at least one message, one or more other messages, or a combination thereof for later presentation at a device.

20. An apparatus of claim 17, wherein the apparatus is further caused to:
cause, at least in part, an initiation of one or more actions associated with the one or more market transactions, wherein the one or more actions include, at least in part, a transmission of a response
message, an establishment of a communication session with a device associated with the at least one message, a generation of an alert message, a presentation of the at least one message in a structured format, or a combination thereof.

21-48. (canceled)
